(19) United States
(12) Patent Application Publication
(10) Pub. No.: US 2022/0309507 A1
(43) Pub. Date: Sep. 29, 2022

(54) MACHINE LEARNING SYSTEM FOR AUTOMATED RECOMMENDATIONS OF EVIDENCE DURING DISPUTE RESOLUTION

(71) Applicant: PAYPAL, INC., San Jose, CA (US)

(72) Inventors: Anthony Ross, San Diego, CA (US); Raymond Buhr, Elmhurst, IL (US)

(21) Appl. No.: 17/211,581

(22) Filed: Mar. 24, 2021

(51) Int. Cl. G06Q 20/40; G06N 20/00; G06Q 20/02

(52) U.S. Cl. CPC G06Q 20/407; G06N 20/00; G06Q 20/02

(57) ABSTRACT

There are provided systems and methods for a machine learning system for automated recommendations of evidence during dispute resolution. A service provider, such as an electronic transaction processor for digital transactions, may provide a dispute resolution system, which allows adjudication of disputes between merchants and customers. The dispute resolution system may employ a machine learning engine that performs evidence classification and recommendation using one or more machine learning models. A first model may be trained to classify evidence based on text and evidence categories. Using the classified evidence, a second model may be trained to recommend evidence that has a highest probability of winning a dispute from past dispute resolutions and those evidence categories submitted to the dispute. The second model may provide one or more evidence categories for a dispute party to submit via a user interface and may rank or otherwise suggest evidence by the user interface.

### TECHNICAL FIELD

The present application generally relates to training machine learning models using dispute evidence and more particularly to building a machine learning system to automate recommendations of evidence based on success probabilities of the evidence.

### BACKGROUND

Service providers, such as online transaction processors, may provide electronic transaction processing services to merchants and customers. As part of the electronic transaction processing services, a service provider may also provide dispute resolution services, such as when an error or disagreement occurs during transaction processing. These disputes may be based on exchanged values, item quality or quantity, delivery, and the like. However, in order to resolve these disputes, the service provider's dispute resolution service may require evidence to support the merchant's and/or customer's position regarding the dispute and determine how to resolve the dispute in favor of one of the sides. Without knowing what evidence causes a positive resolution of the dispute on behalf of the merchant, the merchant may not locate and upload the proper evidence. Further, current systems do not recommend the available types of evidence and/or provide a data storage of available evidence for merchants to easily select and upload evidence during a dispute. This can cause unnecessary time and computing resources for both the service provider and the merchant from notifying the merchant that the evidence is not proper, the merchant determining and locating other evidence, resubmitting new evidence, and processing the resubmission of new evidence.

### BRIEF DESCRIPTION OF THE DRAWINGS

FIG. 1 is a block diagram of a networked system suitable for implementing the processes described herein, according to an embodiment;

FIG. 2 is a block diagram of exemplary interactions by entities when using a machine learning system to recommend evidence during dispute resolution, according to an embodiment;

FIG. 3A is an exemplary list of evidence types to recommend for dispute resolution, according to an embodiment;

FIG. 3B is an exemplary user interface for requesting evidence recommended by a machine learning system for dispute resolution, according to an embodiment;

FIG. 4A is a flowchart for training a machine learning system for automated recommendations of evidence during dispute resolution, according to an embodiment;

FIG. 4B is a flowchart for using a trained machine learning system for automated recommendations of evidence during dispute resolution, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a machine learning system for automated recommendations of evidence during dispute resolution. Systems suitable for practicing methods of the present disclosure are also provided.

In computing systems of service providers, such as online transaction processors, one or more computing platforms may be provided for dispute resolution processes. Dispute resolution or settlement processes on these platfoi ins generally refer to the computing processes to resolve disputes between parties. With regard to online transaction processors, this may correspond to processes to resolve disputes regarding financial transactions, such as between a customer and a merchant. In this regard, an online transaction processor may facilitate processing a transaction electronically, such as via PAYPAL®, Venmo®, or the like. The online transaction processor may provide the transaction processing services to both customers and merchants. When resolving disputes, the online transaction processor may require evidence from each party. The online transaction processor may then internally resolve the dispute, such as where the online transaction processor provide payment card and/or dispute resolution services. However, the online transaction processor may also provide the evidence to one or more card processors, payment gateways, or other external card networks. Such external card networks may then process the evidence during dispute resolution processes.

In order to better recommend evidence for resolving a dispute in favor of a party to the dispute, the online transaction processor may utilize a machine learning (ML) engine and system that provides recommendations of different evidence types based on a positive resolution likelihood or probability of the evidence in resolving the dispute. The evidence may correspond to primary, secondary, tertiary, and further evidence levels, and combinations of evidence may also be recommended based on past probabilities of the evidence types in positively resolving the dispute. The ML engine may use two or more ML models that are trained to classify evidence into evidence types, and thereafter use those evidence types to deteimine recommended evidence for disputes and types of disputes. Thereafter, a party to the dispute may utilize the recommended evidence to determine what evidence to submit, and view changes to the party's probability of winning or positively resolving the dispute in their favor when evidence is submitted by the party.

In this regard, a service provider, which may provide services to users (e.g., merchants and individual customers of merchants) including electronic transaction processing such as online transaction processors (e.g., PayPal®), may allow these users to process transactions, provide payments, provide content, and/or transfer funds between these users. A user may also interact with the service provider to establish an account and provide other information for the user. In various embodiments, in order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and/or financial information. Thereafter, the account may be used for electronic transaction processing, which may cause disputes between merchants and their customers regarding errors or disagreements arising from transactions. When providing a dispute resolution platform and processes, such as to a merchant when a customer raises a dispute (e.g., regarding price, item parameters including quality or quantity, delivery, and the like), the service provider may provide an intelligent evidence recommendation system during dispute resolution. This may utilize trained ML models that classify evidence into different data types and utilize that classified evidence to determine recommended evidence based on winning or success probabilities when resolving a dispute by a party.

For example, the service provider may have one or more ML models first classify evidence of a service provider. In order to train these ML models for evidence classification, the service provider may utilize known evidence types or categories, such as categories of evidence that correspond to a particular name, code, or identifier. For example, a claims resolution system for the service provider and/or other service providers (e.g., credit and/or debit card providers and card processor networks) may have multiple different categories for classifying evidence. A category of evidence may be evidence that provides proof of possession and/or proof of delivery, a device name or identifier (ID) used in a transaction, proof of signature to a transaction, and the like. Different categories of evidence may also correspond to different service providers, card networks, disputes and/or dispute resolution systems, merchants, and the like. Thus, the initial training data may correspond to annotated training data that includes previous evidence for disputes being categorized into different categories and types.

The service provider may use these evidence categories to process evidence submitted in these categories. In this regard, to extract training data from the evidence for the categories, the service provider may utilize text extraction (e.g., from text data, PDF files, and the like), which allows for machine-readable extraction of data. Where images are provided, image processing and image text extraction may be used on the images, such as via Amazon Textract® or the like. Thereafter, using input attributes from the text data and the evidence classification categories, output classifications of evidence may be determined using the ML model trainer. When training the ML model for evidence classification, a Complement Naive Bayes ML model trainer (e.g., algorithm and function) or a Gaussian Naive Bayes ML model trainer may be used, however, other ML model trainers may instead be used depending on system requirements and/or model accuracy.

Once the ML model is trained for evidence classification, the ML model may further be used on unclassified evidence data for the service provider. For example, in past disputes resolved by the service provider through the dispute resolution processes, evidence may be provided for the disputes, but it may not be classified into the categories used for the training data. Thus, the service provider may use the trained ML model to classify this evidence into the categories. This allows for the evidence provided to the service provider during internal dispute resolution to be classified into categories of evidence. Further, the service provider may have data for dispute results for each dispute and a type or category of each dispute (e.g., chargeback, undelivered goods, etc.).

Thus, the service provider may correlate the now classified evidence for dispute to whether the evidence was successful in resolving the dispute by the party providing the dispute. For example, if a merchant is providing proof of delivery (e.g., a delivery signature of the customer on a delivery receipt), that evidence may be categorized as proof of delivery and a corresponding likelihood or probability of that evidence as positively resolving or winning the dispute by the merchant may be determined. Further, the dispute may be identified as a type of dispute corresponding to undelivered goods or the like. Thus, when similar disputes having undelivered goods are received, a probability of provided evidence in winning that dispute type may be determined.

To provide evidence recommendations during disputes, the service provider may further train an ML model for the ML engine using the classified evidence and dispute results. In this regard, the training data may associate the classified evidence with evidence type and/or categories, as well as a corresponding outcome (e.g., success or failure of the dispute for the party submitting the evidence) of the corresponding dispute and dispute type. Since the evidence may be classified using the previous ML model(s), and the disputes may have a corresponding result, the training data may be unannotated. However, one or more data scientists or the like may further annotate the training data based on recommendations and/or probabilities for dispute success of particular evidence types and categories.

Thereafter, an ML model trainer may be used to make predictions and/or classifications of evidence based on their corresponding likelihood and/or probability of that evidence in wining or successfully resolving the dispute on behalf of the party submitting the dispute. For example, where the evidence recommendation ML model is trained to predict types and/or categories of evidence one or more merchants are recommended to submit for particular disputes and/or types of dispute, the ML model may receive a dispute for a merchant, determine a similar dispute and/or type of dispute, and thereafter predict or classify evidence categories into probabilities, levels, or likelihoods of that evidence in being successful in winning the dispute for the merchant. A linear regression ML model trainer may be used to train the ML model(s) for evidence recommendation.

In this regard, the ML model for evidence recommendation may further classify the type or categories of evidence into two, three, or more tiers of evidence that assist in successfully resolving a dispute, such as based on each tier's probability or likelihood of resolving the dispute in favor of the party submitting the evidence (e.g., a merchant using an online transaction processor providing the dispute resolution and evidence recommendation system). For example, in a three-tiered system, primary evidence may correspond to evidence that has a highest probability of winning a dispute (e.g., over a threshold probability, such as 80% or 4/5 disputes) and/or requires only one or two pieces of evidence to win the dispute. Secondary evidence may have a lower threshold than the primary evidence and/or may require two or more pieces of evidence. Finally, tertiary evidence may have the lowest likelihood of winning a dispute and/or require multiple forms of evidence to win a dispute.

Furthermore, when classifying evidence into different tiers, the ML model for evidence recommendation may also make correlations between different evidence types that are successful together or in combination in winning a dispute. These combinations of evidence may also be recommended in one or more tiers. For example, a primary tier may include an evidence combination that has two secondary pieces of evidence from an evidence category or possibly a secondary tier piece of evidence and two or more pieces from a tertiary tier, however, other combinations may also exist based on their corresponding win or success probability in dispute resolution. Thus, when a first type of evidence is submitted, another category of evidence for submission may be determined based on the combinations of evidence available to users. Furthermore, the ML engine may provide continuous training and learning (e.g., a continuous deep learning network) that uses the evidence classification ML model(s) to further train and/or retrain the evidence recommendation ML model(s). This may be done by extracting text data from submitted evidence and disputes to classify the submitted evidence, and thereafter further training or retraining the ML model(s) for evidence recommendation using the classified evidence and dispute results.

Once the ML model(s) of the ML engine have been trained for evidence recommendation during disputes, the ML engine may be deployed to a dispute resolution system. When training the ML model, the training data may be location-specific, such as correlated to a specific geographic location, region, country, or geodemographic segment. This may be due to regulations and/or regulatory compliance with data privacy laws for the location. For example, a country may limit access to and/or use of certain personally identifiable information (PII) or other sensitive personal and/or financial data. Thus, the training data may be scrubbed of the data that is restricted by regulation and/or the regulated data may be obfuscated in the training data. Thus, the ML engine may be location-specific and deployed specifically for evidence recommendation in dispute resolution.

However, other geographic locations without sufficient (e.g., zero or another low number compared to the transaction conducted in that region) dispute resolution history may also want evidence recommendations for dispute resolution. When deploying ML engines for evidence recommendation in these new geographic locations, ML engines may have pretrained models from other past locations. Where the regulations and data privacy laws in a new location may be less restrictive, the ML models may be deployed from the more restrictive regions if the training data is in compliance with the regulations and data privacy laws. However, conversely in locations with more restrictive regulations and data privacy laws, the service provider may be required to train new ML models, such as by using obfuscated and/or scrubbed data for the past locations and/or by obtaining new compliant training data (e.g., scrubbed and/or obfuscated) for the new region. Further, with cross-border dispute, different ML engines may be utilized for different dispute parties or entities in the different regions. For example, a merchant in India selling a product to a US citizen may be provided evidence recommendation through a different ML engine (and therefore may be recommended different evidence), from a merchant in the US selling a product to a US citizen or even Indian citizen. However, where the merchants and/or customers are located in different regions and therefore transact across borders and regions, the data may not be required to be scrubbed or obfuscated.

Once the ML engine has been deployed in one or more dispute resolution systems for evidence recommendations, the ML engine may receive a dispute. The dispute may identify a particular party in the dispute, such as a merchant where the ML engine may be trained to recommend dispute evidence to a merchant. However, the ML engine may also function with the other party (e.g., customer) to the dispute and/or generally for both sides. Once a dispute is received and the corresponding party identified, the ML engine may classify the dispute, such as by correlating the dispute to one or more other disputes and/or classifying the dispute as a particular type of dispute. This may be based on extracting features for the dispute, which may correspond to text and/or other data submitted with the dispute (including customer evidence provided by a customer filing the dispute). These attributes for the dispute may be provided to the ML engine for dispute evidence recommendation based on probabilities of winning and/or successfully resolving the dispute in the party's favor. Additional attributes may also be utilized for evidence recommendation. For example, a product lifecycle may be used to determine particular evidence needed during different stages in the product lifecycle.

Thereafter, the ML engine may determine one or more types of evidence, as well as the evidence's probability in winning the dispute and/or tier ranking (e.g., primary, secondary, tertiary, etc.). Thus, the ML engine may provide output classifications of evidence for use in and response to the dispute based on the input dispute attributes. The dispute resolution platform may display the recommended evidence via one or more user interfaces (UIs), which may present both the probabilities and/or tiers associated with the evidence and the evidence's success rates. The dispute resolution platform may further include one or more APIs to interface with merchant systems in order to provide and/or cause display of the recommended evidence, for example, through API calls executed between the various computing infrastructures and systems. The interfaces may include one or more operations to upload and/or provide the evidence by the merchant or other party. Further, as the party uploads and/or provides evidence, the probability of the party's success in winning the dispute may change and be reflected in the interfaces. For example, after submitting one piece of evidence, an initial probability of success may be displayed, which may change as other evidence is submitted and/or the evidence is confirmed as valid. The ML engine may also determine further categories of evidence for the party to submit after evidence is originally submitted and/or when additional evidence is requested to be submitted. For example, after a first category of evidence is submitted, a second category may be recommended based on win probability and/or evidence tier.

The party may view the dispute status, request dispute adjudication and/or resolution, and/or view a time remaining in the dispute. When requesting dispute resolution, the merchant may also enroll in and/or request chargeback protection, which may correspond to a fee that allows the service provider to adjudicate the dispute. Thus, the merchant may keep the transaction total or receive reimbursement, where the dispute's value is then resolved between the service provider and the customer. Furthermore, the service provider may actively collect and provide a locker of the available data for the party's past transactions and/or interactions that may lead to dispute. For example, a data locker, such as an “evidence locker,” may correspond to a data repository available with the service provider for a merchant's data provided to and/or generated from use of the service provider. When a dispute occurs, the matching evidence from the data locker may be correlated to the dispute so that the merchant is not required to find and upload or submit the evidence. The merchant may then view the available evidence and their corresponding probabilities of success and/or tiers, select evidence to provide from the data locker, and upload any further evidence that may be desired.

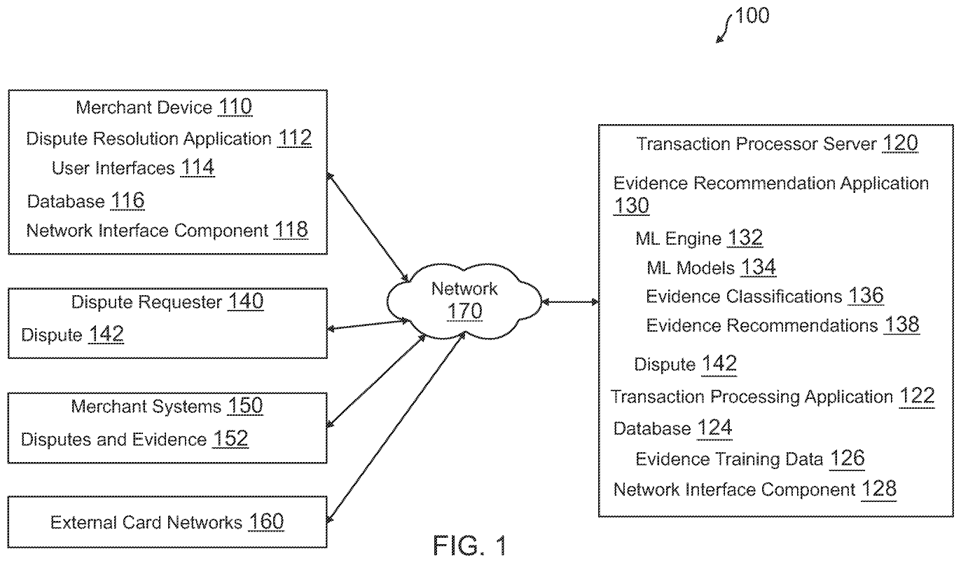

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a merchant device 110, a transaction processor server 120, a dispute requester 140, merchant systems 150, and external card networks 160 in communication over a network 170. Merchant device 110 may be utilized by a merchant, a merchant service provider, or other end user or entity associated with a merchant to access a computing service or resource provided by transaction processor server 120, where transaction processor server 120 may provide various data, operations, and other functions to merchant device 110 via network 170. In this regard, merchant device 110 may be used to request dispute resolution services provided by transaction processor server 120 for a dispute with a user, customer or other end user or entity associated with dispute requester 140. Thereafter, transaction processor server 120 may provide recommendations on evidence to provide during the dispute using an ML engine 132 having ML models 134 trained for evidence classification and recommendation. The evidence may be recommended to increase the chances of having the dispute favorably resolved on behalf of the merchant associated with merchant device 110. The evidence may then be processed internal by transaction processor server 120 and/or provided to external card networks 160 for dispute resolution.

Merchant device 110, transaction processor server 120, dispute requester 140, and merchant systems 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Merchant device 110 may be implemented as a communication device that may utilize appropriate hardware and software configured for wired and/or wireless communication with transaction processor server 120 and dispute requester 140. Merchant device 110 may correspond to a personal computing device for a merchant, for example, a personal computer (PC), a smart phone, laptop/tablet computer, wristwatch with appropriate computer hardware resources, eyeglasses with appropriate computer hardware (e.g. GOOGLE GLASS ®), other type of wearable computing device, implantable communication devices, and/or other types of computing devices capable of transmitting and/or receiving data. In other embodiments, merchant device 110 may correspond to a server, such as a stand-alone or enterprise-class servers, operating an OS such as a MICROSOFT® OS, a UNIX® OS, a LINUX® OS, or another suitable server-based OS. In one example, merchant device 110 may correspond to a device of a merchant that utilizes PAYPAL®, Inc. of San Jose, Calif., USA for transaction processing. However, in other embodiments, merchant device 110 may be maintained by another type of entity.

Although only one device is shown, a plurality of devices and/or servers may function similarly and/or be connected to provide the functionalities described herein.

Merchant device 110 of FIG. 1 contains a dispute resolution application 112, a database 116, and a network interface component 118. Dispute resolution application 112 may correspond to executable processes, procedures, and/or applications with associated hardware. In other embodiments, merchant device 110 may include additional or different modules having specialized hardware and/or software as required.

Dispute resolution application 112 may correspond to one or more processes to execute software using associated hardware components of merchant device 110 to provide features, services, and other operations for a merchant, seller, administrator, team, or the like associated with merchant device 110 to request dispute resolution and provide evidence during dispute resolution. In this regard, dispute resolution application 112 may be utilized by a user of merchant device 110 to access a website or portal provided by transaction processor server 120 via UIs 114 during dispute resolution. For example, dispute resolution application 112 may be used to receive a dispute regarding a transaction or other activity or interaction by the merchant associated with merchant device 110 and a customer or other user associated with dispute requester 140. The dispute may correspond to an error, issue, conflict, or disagreement from the transaction, such as a product not received, a wrong or defective product received, or incorrect item/price total. The dispute may also relate to fraud and/or malicious activities, including account takeover. Dispute resolution application 112 may be used to view the dispute via one or more of UIs 114. Dispute information for the dispute may be displayed through one or more of UIs 114, such as dispute details (e.g., issue raised by a customer, underlying transaction being dispute, and the like). One or more of UIs 114 may also display recommended evidence for the dispute and information to submit the recommended evidence. The recommended evidence may be determined by transaction processor server 120 using ML engine 132, as described herein.

Dispute resolution application 112 may be utilized by the merchant to view one or more of UIs 114, for example, via graphical UIs (GUIs) presented using an output display device of merchant device 110. UIs 114 may enable the merchant associated with merchant device 110 to access the dispute resolution portal and/or application of transaction processor server 120 and provide the evidence in response to the dispute, including the recommended evidence. Additionally, APIs and API integrations through calls, requests, and responses may be utilized between dispute resolution application 112 and one or more applications, platforms, and/or services of transaction processor server 120. Such API interactions may cause UIs 114 to present the recommended evidence though the output display device or component of merchant device 110. Dispute resolution application 112 may be used to upload the evidence or may be used to select the evidence from evidence available in a data or evidence locker maintained by transaction processor server 120 for the merchant (e.g., based on past transaction processing). Dispute resolution application 112 may then be used to view changes caused by submission of evidence, submit more evidence recommended by transaction processor server 120 (e.g., in a further category and/or tier of evidence), and/or request dispute resolution for the dispute. In various embodiments, merchant device 110 may further include additional application for electronic transaction processing, such as applications for a merchant marketplace, sales, payment, electronic transaction processing, inventory, and the like.

Merchant device 110 may further include database 116 stored on a transitory and/or non-transitory memory of merchant device 110, which may store various applications and data and be utilized during execution of various modules of merchant device 110. Database 116 may include, for example, identifiers such as operating system registry entries, cookies associated with dispute resolution application 112, identifiers associated with hardware of merchant device 110, or other appropriate identifiers, such as identifiers used for payment/user/device authentication or identification, which may be communicated as identifying the user/merchant device 110 to transaction processor server 120. Moreover, database 116 may include UI data for display of UIs 114 and other data and operations for transaction processor server 120, as well as stored evidence data and other data related to disputes and their underlying transactions. Evidence data stored by database 116 may be uploaded to transaction processor server 120 for processing during dispute resolution.

Merchant device 110 includes at least one network interface component 118 adapted to communicate with transaction processor server 120 and/or dispute requester 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor server 120 may be maintained, for example, by an online service provider, which may provide operations for evidence recommendations that increase chances of success in winning disputes with a dispute resolution system. The dispute resolution system may be provided internally by transaction processor server 120 or by external card networks 160. In the latter, transaction processor server 120 may interface with external card networks 160 for evidence recommendations and/or provide evidence from merchant device 110. Transaction processor server 120 includes one or more processing applications which may be configured to interact with merchant device 110 to display UIs 114 on merchant device 110 that are used to provide evidence recommendations using ML engine 132. In one example, transaction processor server 120 may be provided by PAYPAL®, Inc. of San Jose, Calif., USA. However, in other embodiments, transaction processor server 120 may be maintained by or include another type of service provider.

Transaction processor server 120 of FIG. 1 includes an evidence recommendation application 130, a transaction processing application 122, a database 124, and a network interface component 128. Evidence recommendation application 130 and transaction processing application 122 may correspond to executable processes, procedures, and/or applications with associated hardware. In other embodiments, transaction processor server 120 may include additional or different modules having specialized hardware and/or software as required.

Evidence recommendation application 130 may correspond to one or more processes to execute software using associated hardware components of transaction processor server 120 to provide a platform, website, and/or application to implement ML engine 132 for evidence recommendations during disputes adjudicated by a dispute resolution platform of transaction processor server 120. In this regard, evidence recommendation application 130 may be used by transaction processor server 120 to train ML models 134 for ML engine 132 in order to provide evidence recommendations. For example, when training ML models 134 for ML engine 132, evidence recommendation application 130 may utilize one or more ML trainers, which may include operations for training a linear regression ML model for evidence recommendation, as well as a Complement Naive Bayes ML model or a Gaussian Naive Bayes ML model for evidence classification. For example, an ML model trainer may train ML models 134 based on training data. Where one or more of ML models 134 are used to perform evidence classification, the training data may be evidence and categories or types of that evidence. This may correspond to codes or categories that were previously used to classify evidence submitted in past disputes. Where one or more of ML models 134 are used to perform evidence recommendation, the training data may be evidence categories or types and results of their corresponding dispute (e.g., success or failure to win a dispute, including win likelihood or probability over a group of disputes).

When building ML models 134, the training data may be used to generate one or more classifiers and provide recommendations, predictions, or other outputs based on those classifications and an AI model. For example, ML models 134 may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output values or classifications. Within the input layer, each node may correspond to a distinct attribute or input data type that is used to train ML models 134.

Thereafter, the hidden layer may be trained with these attributes and corresponding weights using an AI algorithm, computation, and/or technique. For example, each of the nodes in the hidden layer generates a representation, which may include a mathematical AI computation (or algorithm) that produces a value based on the input values of the input nodes. The AI algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for ML models 134 that attempt to classify evidence and/or recommend evidence. Thus, when ML models 134 are used to perform a predictive analysis and output, the input may provide a corresponding output based on the classifications trained for ML models 134.

Thus, ML models 134 may be trained by using training data described herein. By providing training data to train ML models 134, the nodes in the hidden layer may be trained (adjusted) such that an optimal output (e.g., a classification) is produced in the output layer based on the training data. By continuously providing different sets of training data and penalizing ML models 134 when the output of ML models 134 is incorrect, ML models 134 (and specifically, the representations of the nodes in the hidden layer) may be trained (adjusted) to improve its performance in data classification. Adjusting ML models 134 may include adjusting the weights associated with each node in the hidden layer.

Thus, the training data may be used as input/output data sets that allow for ML models 134 to make classifications based on input attributes. The output classifications for an ML model trained for evidence classifications 136 may be classifications of the categories and/or codes for uncategorized evidence. The output classifications for an ML model trained for evidence recommendations 138 may be classifications of the categories and/or types of evidence recommended for a dispute or dispute type (e.g., based on dispute details or attributes) from win probabilities of evidence classifications 136. Evidence classifications 136 may include evidence previously classified into categories, such as by a data scientist, administrator, machine or other entity that classifies the evidence to categories or otherwise annotates the training data for evidence classification. Evidence classifications 136 may also include the uncategorized data now classified into categories by one or more of ML models 134. Thereafter, evidence classifications 136 may be used to further train one or more of ML models 134, which the provides evidence recommendations 138 based on received disputes.

When receiving dispute 142 from a merchant and/or customer, ML engine 132 may determine one or more of evidence recommendations 138 based on win probabilities, percentages, and/or likelihoods when used as evidence in past disputes. The output recommendations from evidence recommendations 138 may include those ranked by win probability, as well as win probability tier. Further, the output recommendations may include combinations of evidence that may increase a probability of winning dispute 142. This may include suggesting further categories of evidence to submit after one or more initial pieces or items of evidence are submitted, as well as providing changes to win probability based on submission of further evidence from one or more evidence categories. Where merchant device 110 requests the evidence recommendations, the recommended evidence may be that evidence that a merchant associated with merchant device 110 may provide.

When submitting evidence, evidence recommendation application 130 may provide a data or evidence locker, which includes collected and aggregated data on behalf of the merchant associated with dispute 142 (or customer, where the customer is requesting evidence recommendation). This may include a data store and corresponding interface or interface elements connectable to the data store that allow the merchant to select data collected by evidence recommendation application 130 and attach or submit the data with dispute 142 for dispute adjudication. This allows the merchant to no longer have to upload data, while recommendations of data from the locker may be provided by ML engine 132. Evidence recommendation application 130 may further be used to provide chargeback protection, where a merchant may request that transaction processor server 120 perform an adjudication of dispute 142 (e.g., for a fee), where the merchant is not responsible for, or responsible only for a portion of, a chargeback from dispute 142. Thereafter, evidence recommendation application 130 may automate dispute resolution and evidence submission for dispute 142.

Transaction processing application 122 may correspond to one or more processes to execute software using associated hardware components of transaction processor server 120 to process a transaction or provide another service to merchants and customers of transaction processor server 120, which may utilize dispute resolution processes of a dispute resolution platform. In some embodiments, transaction processing application 122 may be used by a user associated with merchant device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by transaction processor server 120. The payment account may be accessed and/or used through a browser application and/or dedicated payment application executed by merchant device 110 and engage in transaction processing through transaction processing application 122.

Transaction processing application 122 may process the payment and may provide a transaction history to merchant device 110 for transaction authorization, approval, or denial. The transaction history and other data may be associated with dispute 142 and may be used as evidence in resolving dispute 142. In some embodiments, the transaction data may also be stored by transaction processor server 120 in a data or evidence locker for the merchant associated with merchant device 110. Transaction processing application 122 may therefore generate data used by a dispute resolution platform. In various embodiments, the dispute resolution platform of transaction processor server 120 may be provided by transaction processing application 122, for example, through the transaction processing and/or account features of transaction processing application 122. However, in other embodiments, the dispute resolution platform may be provided by another application or service of transaction processor server 120, including evidence recommendation application 130. Further, the dispute resolution platform may be external, such as dispute resolution platforms provided by external card processors accessible over external card networks 160. Thus, in some embodiments, dispute evidence recommended and received by transaction processor server 120 may be provided over external card networks 160 for processing with dispute 142.

Additionally, transaction processor server 120 includes database 124. Database 124 may store various identifiers associated with merchant device 110. Database 124 may also store account data, including payment instruments and authentication credentials, as well as transaction processing histories and data for processed transactions. Database 124 may store financial information and tokenization data, as well as transactions, transaction results, and other data generated and stored by transaction processing application 122. Further, database 124 may include transaction and dispute information, which may be used by evidence recommendation application 130 in recommending evidence and/or adjudicating a dispute. For example, evidence training data 126 for ML models 134 may be stored by database 124, which may include both evidence classification training data and/or evidence recommendation training data (e.g., associated with evidence classifications 136 and/or evidence recommendations 138 for ML models 134).

In various embodiments, transaction processor server 120 includes at least one network interface component 128 adapted to communicate merchant device 110, dispute requester 140, merchant systems 150, and/or external card networks 160 directly and/or over network 170. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Dispute requester 140 may be maintained, for example, by a customer or other end user, which may engage in electronic transaction processing and further request dispute resolutions for errors or disagreements in the transaction processing. In this regard, dispute requester 140 may correspond to a customer engaging in dispute 142 with merchant device 110, where transaction processor server 120 provides evidence recommendations for dispute 142. Dispute 142 may therefore be processed using evidence recommendation application 130 and/or one or more processes for dispute resolution with transaction processor server 120. In one example, disputer requester 140 may correspond to a device of a customer that utilizes PAYPAL®, Inc. of San Jose, Calif., USA for transaction processing. However, in other embodiments, dispute requester 140 may be maintained by another type of entity.

Merchant systems 150 may be maintained, for example, by one or more online merchants and/or merchant marketplaces, as well as card processors and other financial systems that facilitate electronic transaction processing. In this regard, merchant systems 150 may provide disputes and evidence 152 based on past processed transactions and their corresponding disputes. Disputes and evidence 152 may be provided to transaction processor server 120 initially as training data for one or more of ML models 134, such as an ML model configured to provide evidence classifications. Thus, merchant systems 150 may provide one or more categories, identified by a code or other identifier, for evidence in disputes and evidence 152, as well as their corresponding dispute results and/or attributes. However, in other embodiments, disputes and evidence 152 may include uncategorized data required to be categorized by ML models 134 and then used for evidence recommendations. In one example, merchant systems 150 may correspond to merchants that utilize PAYPAL®, Inc. of San Jose, Calif., USA for transaction processing. However, in other embodiments, merchant systems 150 may be maintained by another type of entity.

External card networks 160 may correspond to card processing networks, such as debit or credit card processing networks (e.g., VISA®, MASTERCARD®, AMEX®, and the like). Thus, external card networks may include card processing gateways and backend card processors to process transactions when payment cards are used in the transaction. In this regard, external card networks 160 may provide dispute resolution services via one or more dispute resolution platforms, which allow for adjudication of disputes for card transactions (e.g., dispute 142). Where external card networks 160 are used to provide dispute resolution, transaction processor server 120 may provide evidence recommendations using ML engines, as discussed herein. Transaction processor server 120 may therefore receive and/or collect evidence for the disputes, and thereafter provide the evidence on behalf of a party (e.g., the merchant associated with merchant device 110) over external card networks 160 for dispute resolution.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

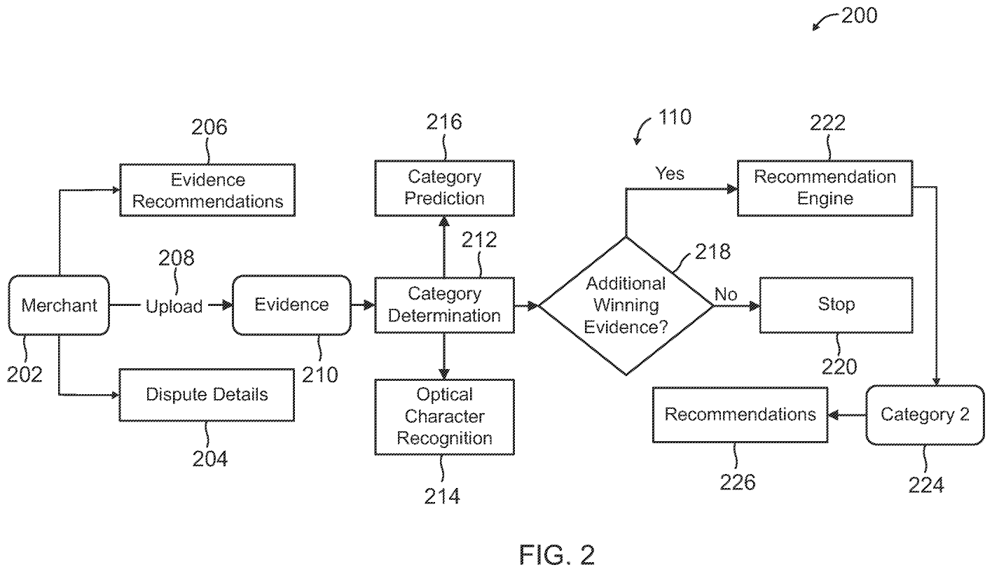

FIG. 2 is a block diagram 200 of exemplary interactions by entities when using a machine learning system to recommend evidence during dispute resolution, according to an embodiment. Block diagram 200 includes a merchant 202 providing evidence during a dispute to a dispute management system that provides evidence recommendations, such as transaction processor server 120 discussed in reference to system 100 of FIG. 1. In this regard, the merchant may utilize merchant device 110, where merchant device 110 and transaction processor server 120 may operate within block diagram 200 to provide and process evidence based on evidence recommendations.

Merchant 202 may be engaged in a dispute with a customer or other user, which may be associated with dispute details 204. Based on dispute details 204, evidence recommendations 206 may be provided to merchant 202, which may correspond to the different categories of evidence recommended for the merchant 202 to provide based on dispute details 204. Evidence recommendations 206 may include evidence recommended based on a win probability of the evidence category (e.g., the top three or five most likely evidence categories to win a dispute) or the win probability exceeding a threshold win probability. In this regard, when exceeding a threshold, multiple thresholds may be used, and different tiers of evidence may be ranked and provided. Based on evidence recommendations 206, merchant 202 may provide an upload 208 of evidence 210.

From evidence 210, the dispute resolution and/or evidence recommendation system of transaction processor may perform data processing during a category determination 212. Category determination 212 may process evidence 210 to confirm the evidence type and details of the evidence (e.g., confirmation of proof of delivery, transaction total, credit card charge total, delivery address, item type or quantity, etc.). In this regard, an optical character recognition 214 or other text extraction process (e.g., direct text extraction, image processing, and the like) may be used to determine the data within evidence 210 and perform a category prediction 216. For example, after processing evidence 210 during category determination 212 to extract data from evidence 210, category prediction 216 may predict a category or type for evidence 210 and associated evidence 210 with the category. This may correspond to the category that merchant 202 initially correlated the evidence with, or a different category if the extracted data indicates otherwise. Processing of evidence data may be done by an evidence classification ML model based on the extracted data for evidence 210. Thus, evidence 210 may further be classified during dispute resolution.

After processing of evidence 210, merchant 202 may be queried for additional winning evidence 218 or additional evidence that improves the chances of winning the dispute, and if no additional winning evidence is indicated by merchant 202 (e.g., merchant 202 does not have additional evidence to provide to win the dispute), then evidence recommendations by the ML engine may proceed to block 220, which stops further recommendations. However, where further evidence is available, recommendation engine 222 may be engaged to process dispute details 204 and/or evidence 210 and provide one or more further recommendations. For example, an evidence recommendation ML model of recommendation engine 222 may be used to predict or recommend further evidence to win or improve chances of winning the corresponding dispute. For example, the evidence recommendation ML model may predict a category two 224 may further assist in winning the dispute. Category two 224 may correspond to one or more additional categories of evidence recommended to win the dispute, such as based on one or more highest win probabilities, thresholds, and/or tiers of evidence based on win probabilities. Thereafter, merchant 202 may be provided recommendations 226. Recommendations 226 may be viewed via one or more UIs of the dispute resolution portal where merchant 202 may upload or select additional evidence to provide for the dispute.

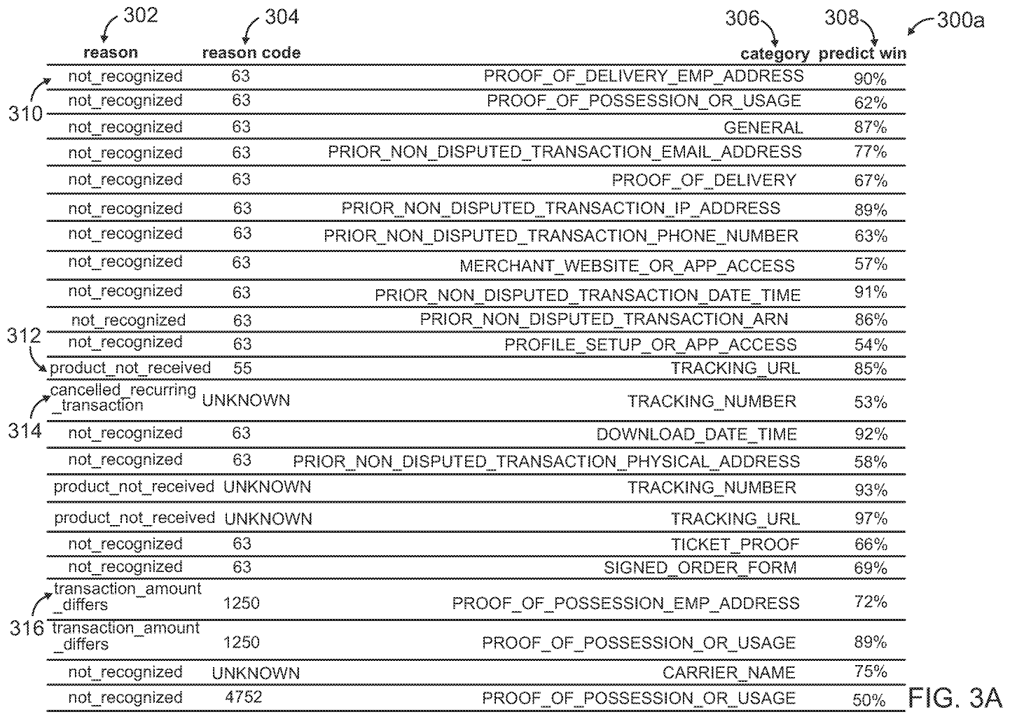

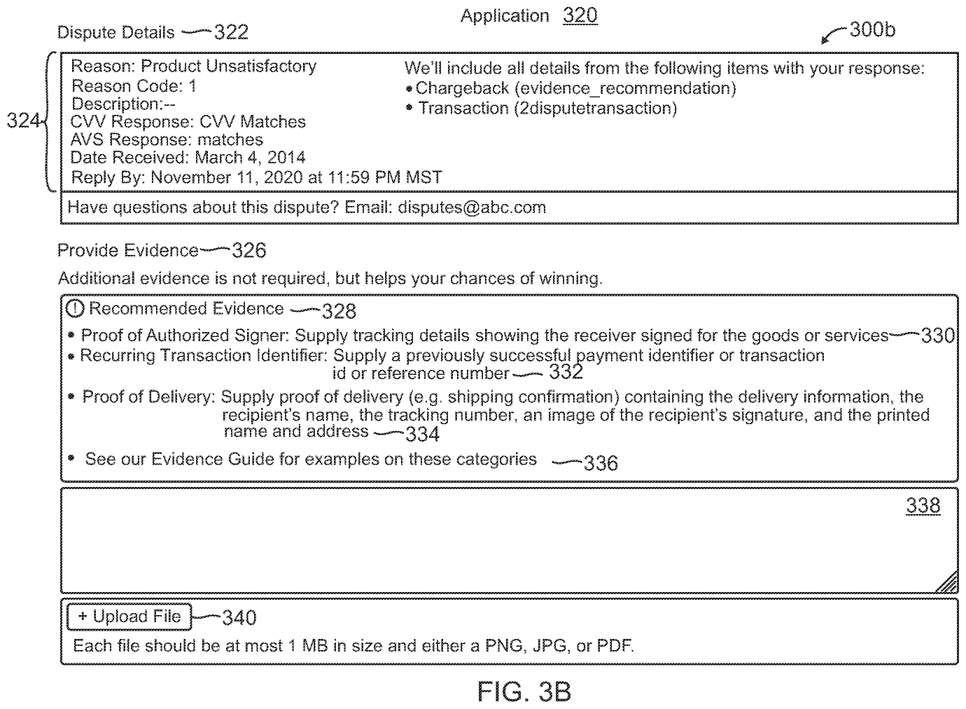

FIG. 3A is an exemplary list 300a of evidence types to recommend for dispute resolution, according to an embodiment. List 300a displays disputes and corresponding evidence categories with their predicted win percentages as determined by a ML engine for evidence classification and recommendation provided by transaction processor server 120 discussed in reference to system 100 of FIG. 1. List 300a may correspond to data used by an ML model for evidence recommendations, for example, by determining evidence categories that have a highest probability of winning a dispute.

In list 300a, different disputes types are shown based on a reason 302 for submitting evidence categories in list 300a. Reason 302 may be associated with a reason code 304 for submitting the evidence, such as a dispute and/or evidence category or identifier with an internal or external system used in dispute claim resolution. Further, for each reason 302, a category 306 corresponding to the evidence submitted may be listed. With category 306, a predicted win percentage 308 may also be listed, which corresponds to a likelihood or probability of category 306 winning a dispute corresponding to reason 302.

For example, in dispute data 310, reason 302 is shown as “not recognized,” indicating the dispute reason or attributes may not be yet labeled and/or classified by the ML model. However, dispute data 310 is associated with a reason code 304 of “63”, a category 306 or “Proof of Delivery EMP Address” and a predicted win percentage 308 of 90%. Thus, when correlating category 306 to a dispute for dispute data 310, a high likelihood of success is predicted after training the ML model. Thus, category 306 may be a recommended type of evidence, such as a primary type or tier of evidence to recommend, for a corresponding dispute.

With dispute data 312, reason 302 is known and shown as “product not received”. Further, reason code 304, category 306, and predicted win percentage 308 are also known. Category 306 is shown as a different evidence category, a “Tracking URL”. Further, predicted win percentage 308 is lower at 85%, and therefore may correspond to a secondary type of evidence to submit for a corresponding dispute. This may occur when another evidence category has predicted win percentage 308 at an amount similar to dispute data 310. Further, dispute data 316 includes reason 302 as “transaction amount differs,” with a corresponding predicted win percentage 308 of 72%, which may correspond to a tertiary type of evidence if higher predicted win probabilities are available for reason 302 of “transaction amount differs”.

Further, using the data in list 300a, further reasons, reason codes, and the like that allow correlating evidence categories to dispute types and attributes may be determined by a ML model. For example, during processing of additional data, “not recognized” and/or “unknown” labels may be determined through further training of the ML model. For example, dispute data 310 and dispute device 314 have “not recognized” and “unknown” labels respectively, in their data. Using the ML model, additional classifications may be made and determined during and/or after training.

FIG. 3B is an exemplary user interface 300b for requesting evidence recommended by a machine learning system for dispute resolution, according to an embodiment. UI 300b of FIG. 3B includes information displayed by a computing device, such as merchant device 110 from system 100 of FIG. 1, in an application 320 when accessing a dispute resolution and/or evidence recommendation portal. In this regard, application 320 may correspond to a web browser or dedicated rich application corresponding to dispute resolution application 112 in system 100, wherein UI 300b may correspond to one of Uls 114 from dispute resolution application 112.

Application 320 provides information for a merchant (or other entity) to review for evidence recommendations and submit evidence during dispute resolution. In this regard, application 320 includes dispute details 322, which include dispute data fields 324 for known data for a corresponding dispute. In one such field, the dispute is shown for a reason of “Product Unsatisfactory.” Dispute data fields 324 may correspond to the input attributes for an evidence recommendation ML model and may therefore be utilized to determine recommended evidence to provide in order to win the corresponding dispute. Dispute details 322 may also allow the merchant to fill out information within dispute data field 324 if additional dispute information in required or may assist in evidence recommendation.

Application 320 further includes a provide evidence 326 field that allows a merchant to submit evidence in response to the dispute, which may increase the merchant's chances of winning the dispute and/or avoiding a chargeback, refund, or the like. For example, based on dispute details 322, recommended evidence 328 is provided to the merchant in application 320. Recommended evidence 328 may be based on win probabilities identified by the evidence recommendation ML model based on training data of evidence classifications and dispute results (e.g., for dispute attributes and/or types). In this regard, recommended evidence 328 includes three types of evidence to submit, although more or less types may be used. Each type of evidence may further be associated with a win probability and/or tiered ranking, which may be shown and/or further accessible through selection of links and data in application 320. Recommended evidence 328 may be shown in order of win probability or tier or may be shown as a group of highest rated evidence for dispute resolution.

For recommended evidence 328, the evidence recommendation ML model recommends a proof of authorized signer 330, a recurring transaction identifier 332, and a proof of delivery 334. Further, for recommended evidence 328, the merchant may be provided with an evidence guide 336 to view examples of the categories and/or learn more about each category. The dispute was previously shown as a reason of “Product Unsatisfactory.” With a proof of authorized signer 330, the merchant may prove that the product was satisfactorily received by the customer or other entity. With a recurring transaction identifier 332, the merchant may prove that the customer has previously processed the same or similar transaction. Additionally, with a proof of delivery 334, the merchant may prove that the product was properly delivered to the customer. Thereafter, an evidence field 338 may show evidence uploaded by the merchant, which is currently empty. Thus, the merchant may use recommended evidence 328 to determine files to provide in evidence field 338 for submission with the dispute for adjudication. An upload field 340 may provide options for the merchant to upload data. Further, where a data or evidence locker is provided of previously stored data, evidence field 338 and/or upload field 340 may include data already available to the dispute resolution platform for use with the dispute.

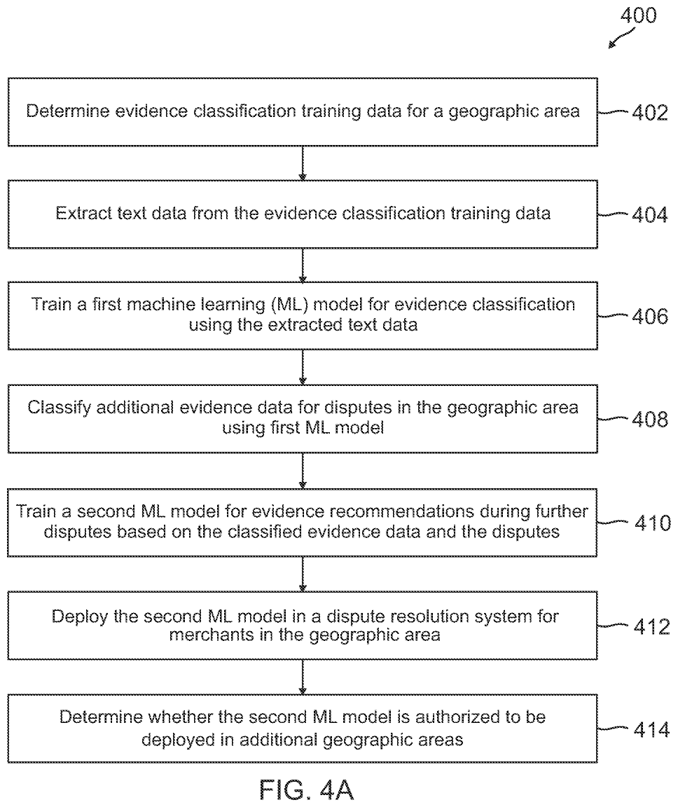

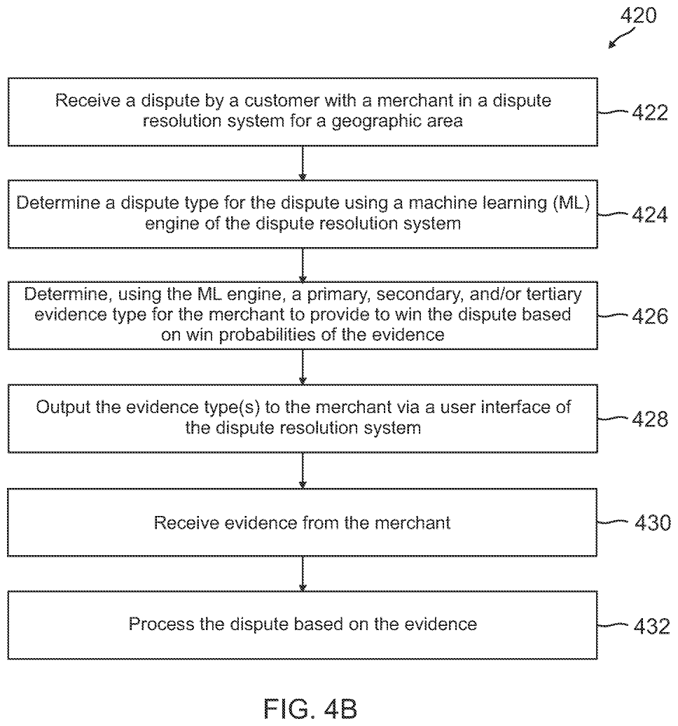

FIG. 4A is a flowchart 400 for training a machine learning system for automated recommendations of evidence during dispute resolution, according to an embodiment. Note that one or more steps, processes, and methods described herein of flowchart 400 may be omitted, performed in a different sequence, or combined as desired or appropriate.

At step 402 of flowchart 400, evidence classification training data for a geographic area is determined, such as a geographic location, region, country, or the like. The evidence classification training data may be specific to a certain area or region, such as based on regulations, privacy laws, and the like. For example, a geographic region may correspond to the European Union, which may have regulations for multiple different countries. The geographic area may correspond to individual countries, such as China, India, or the like. The geographic area may also be smaller than a country or group of countries, including individual US states, city-states (e.g., Singapore), cities, areas corresponding to certain demographics, and the like. Each geographic area may have data privacy laws and regulations, and thus, the evidence classification training data may be required to be scrubbed of certain data and/or the data may be required to be obfuscated within the training data when training a model in a specific region.

Further, the geographic area may apply to either or both of the customer and the merchant for the selection and cleaning of the training data. For example, the customer location may designate what privacy law protects customer data used in the training data for evidence recommendation (e.g., customer PII or financial data). However, merchants may reside is multiple geographic areas, such as nationwide or international merchants (e.g., AMAZON® or EBAY®). Thus, a merchant spanning multiple geographic areas (e.g., regions our countries) may have different ML models trained for evidence classification and recommendation for different geographic areas. The dispute resolution system and/or online transaction processor may also merge models for different geographic areas on behalf of this type of merchant, for example, if merging the models is compliant with data privacy laws and regulations. In such embodiments, the models may be merged if the training data would not be compromised or if regulated user data is not required by the models (e.g., if the required input attributes may be determined from a dispute without compromising regulated data). Thus, an international merchant may be provided synergy between different local models by the dispute resolution system depending on data privacy laws and regulations.

The evidence classification training data may include classified and/or annotated evidence in categories, such as by category code or identifier. For example, different ML models and engines (e.g., for evidence classification and recommendation) may be trained for different card processors and networks (e.g., VISA®, MASTERCARD®, AMEX®, etc.). Each card processor may have different codes or identifiers for disputes, different dispute resolution processes, and/or different evidence used to resolve disputes. Thus, different evidence may be recommended based on what evidence is predicted to win disputes for the corresponding card processor and dispute resolution platform, and therefore, ML models may be trained to be specific to one or more card processors and dispute resolution platforms. However, more universal ML models may also be trained across multiple card processors, including internal card processors of a transaction processor providing the evidence recommendation processes described herein. At step 404, text data is extracted from the evidence classification training data. Where the training data includes documents or PDFs that include direct text, the text may be machine-readable. However, with images or where the text may be written or otherwise inserted to evidentiary documents, a text extraction and/or image processing technique may be employed to extract the text data.

At step 406, a first ML model for evidence classification is trained using the extracted text data. The first ML model may be trained using attributes from the evidence classification training data, including those attributes identified from the extracted text data (e.g., words, phrases, and the like that may be converted to vectors for vector comparisons and the like when training layers of a ML model). Further, the input attributes may include the evidence categories corresponding to the extracted text data. For example, the evidence in the training data may be classified as categories or types corresponding to codes or identifiers such that the extracted text data may then be correlated to these categories. This data therefore allows training of the first ML model to make classifications of text from other evidence into categories from the training data.

Next, at step 408, additional evidence data for disputes in the geographic area is classified using the first ML model. Uncategorized data may correspond to additional evidence not previously categorized for disputes adjudicated by a dispute resolution platform. For example, past disputes may not use evidence categories and/or have uncategorized evidence but may have dispute results. Thus, to use this evidence to train another ML model for evidence recommendation, this evidence is required to be classified. When classifying the additional evidence data, text data may further be extracted from this data and used as input attributes, which is then classified by the first ML model. In some embodiments where the first ML model may be used in further geographic areas, evidence data from those geographic areas may also be used. This may include if the evidence is regulatorily compliant, scrubbed, and/or obfuscated of noncompliant data.

Thereafter, at step 410, a second ML model for evidence recommendation during further disputes is trained based on the classified evidence data and the disputes. The second ML model may be trained to make recommendations of evidence for pending disputes based on probabilities of winning the disputes by submitting the evidence. To train the second ML model, the training data may include attributes for the disputes, such as dispute type and/or dispute details or other data, as well as the evidence categories and their corresponding disputes' results (e.g., was the dispute successfully resolved and won by the merchant or other entity submitting the evidence or not). The second ML model may therefore determine the best evidence, the evidence having a highest probability, and/or the evidence exceeding one or more tiers or thresholds that is successful in resolving a specific dispute type.

At step 412, the second ML model is deployed in a dispute resolution system for merchants in the geographic area, which may include platforms and interfaces to dispute transactions, submit evidence, and/or view dispute results, as well as an evidence recommendation ML engine. The dispute resolution system may therefore allow a merchant to view evidence recommendations during disputes, as discussed further with regard to FIG. 4B. The dispute resolution system may be limited to the geographic area such that only merchants in the geographic area may use the system. However, for cross-border transactions and the like with a customer residing in the geographic area, other merchants may also use the dispute resolution system. Furthermore, merchants and/or customers located in the same geographic area but outside the geographic area where the second ML model is deployed may be provided use of the second ML model for evidence recommendation where authorized and consented to use.

At step 414, it is determined whether the second ML model is authorized to be deployed in additional geographic areas. For example, the transaction processor associated with the dispute resolution system may wish to deploy the second ML model for evidence recommendation in another country, but the country has different privacy laws. Thus, if the regulations and data privacy laws in the second country are less restrictive, the second ML model may be deployed if compliant with the regulations and data privacy laws. However, conversely with more restrictive regulations and data privacy laws, the second ML model may not be authorized to be deployed and a new model may be trained. If regulations and/or privacy laws do not allow use of the specific user or PII data in another geographic area, the data may be scrubbed and/or obfuscated of the noncompliant data or other data may be used. Furthermore, the transaction processor may determine whether the merchants and/or customers share geographic areas, which may allow use in the other area as the data has already been shared and used.

FIG. 4B is a flowchart 420 for using a trained machine learning system for automated recommendations of evidence during dispute resolution, according to an embodiment. Note that one or more steps, processes, and methods described herein of flowchart 420 may be omitted, performed in a different sequence, or combined as desired or appropriate.

At step 402 of flowchart 420, a dispute by a customer with a merchant is received in a dispute resolution system for a geographic area. The dispute may include dispute information, details, or other information. At step 424, using this information, a dispute type for the dispute is determined using a ML engine of the dispute resolution system. The dispute type may correspond to an identifier and/or grouping for the dispute, such as data that allows the dispute to be correlated with one or more other disputes used to train an ML model of the ML engine. The dispute type may therefore correspond to input attributes for the ML engine to make predictions of recommended evidence. Further information may also be used as input attributes for decision-making by the ML engine, including a product lifecycle, dispute lifecycle, and the like.

At step 426, using the ML engine, a primary, secondary, and/or tertiary evidence type for the merchant to provide to win or improve chances of winning the dispute is determined, such as based on win probabilities of the evidence. The ML engine may make predictions of evidence based on the dispute's attributes and the evidence that is shown to most likely win the dispute from past disputes. Thus, the evidence may be ranked according to the win probability, and the ML engine may identify those categories of evidence that have a highest probability of winning the dispute. The ML engine may determine one or more highest probability evidence categories or may select those exceeding a threshold or falling into particular tiers. Further, the ML engine may correlate evidence that has a high probability when submitted together, as well as additional categories of evidence to submit when a first category is submitted.

At step 428, the evidence type(s) are output to the merchant via a UI of the dispute resolution system. For example, a UI may display the dispute and may make recommendations of dispute evidence, as well as information on how to submit the evidence and what the evidence should appear as or include. Further, the UI may additionally include rankings, tiers, and/or win probabilities for each recommended evidence. The UI may provide an option to upload and/or select available evidence to submit, such as from a data or evidence locker for data collected by the dispute resolution system.

Using the UI, at step 430, evidence from the merchant is received. The evidence may include text and/or images, which may require text extraction to determine the corresponding text data in the evidence. Once the text data is determined, the evidence may be classified and provided with the corresponding evidence category for dispute resolution. However, where the evidence is in an evidence locker, the evidence may be preprocessed and associated with a particular evidence category, as well as having text data extracted for dispute resolution. Thereafter, at step 432, the dispute is processed based on the evidence. This may include submitting the evidence with the dispute for dispute resolution and determining a result. Further, the ML models of the ML engine may be continuously trained or retrained based on the dispute and results.

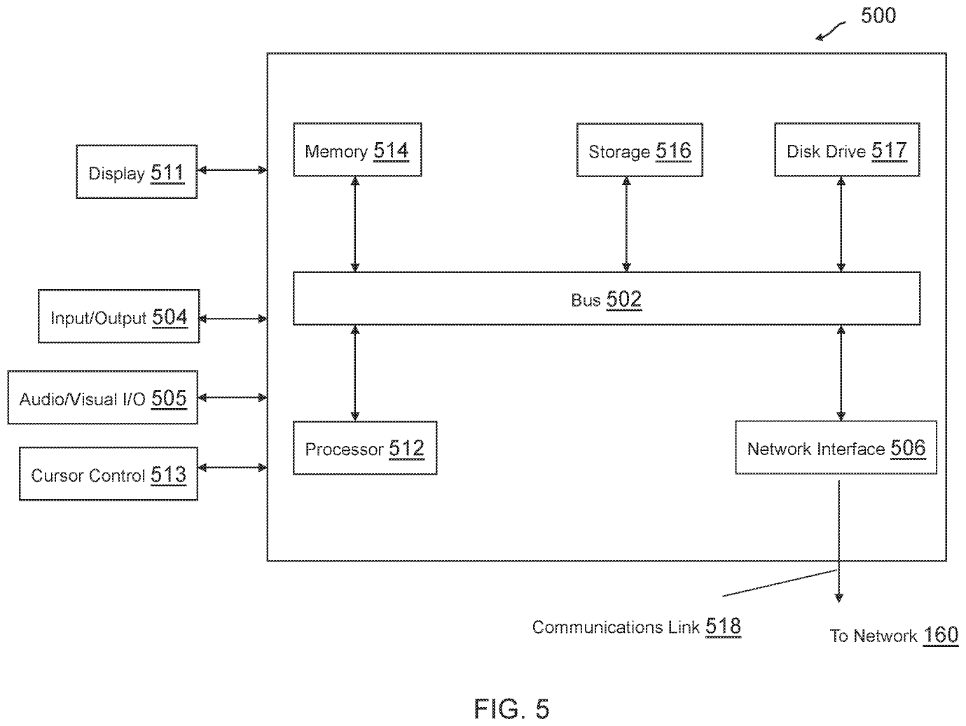

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving, from a computing system of a merchant, a dispute resolution request of a chargeback initiated by a customer with the merchant;
determining dispute data for the chargeback, wherein the dispute data comprises one or more data variables associated with requesting the chargeback by the customer;
classifying, using a machine learning (ML) engine trained from a plurality of previous chargeback results, the chargeback as one of a plurality of dispute types;
determining, using the ML engine, a recommendation of dispute evidence for a resolution of the chargeback by the merchant based on the dispute data and the classified chargeback;
requesting the dispute evidence from the merchant for the dispute resolution request of the chargeback;
receiving the dispute evidence from the merchant; and
processing the dispute resolution request based on the dispute evidence.

2. The system of claim 1, wherein prior to receiving the dispute resolution request, the operations further comprise:
receiving training data for an evidence recommendation ML model of the ML engine, wherein the training data comprises input evidence classifications and chargeback dispute variables; and
training the evidence recommendation ML model for evidence recommendation using the training data.

3. The system of claim 2, wherein the training data comprises a plurality of past resolved chargebacks having received evidence during the plurality of past resolved chargebacks, and wherein the operations further comprise:
extracting text data from the received evidence using at least one of a text extraction operation or an optical character recognition operation;
classifying, using an evidence classification ML model of the ML engine based on the extracted text data, the received evidence for the plurality of past resolved chargebacks into the input evidence classifications based on a plurality of evidence classifications; and
determining the chargeback dispute variables from the plurality of past resolved chargebacks.

4. The system of claim 3, wherein the evidence recommendation ML model comprises a linear regression ML model, and wherein the evidence classification ML model comprises one of a Complement Naive Bayes ML model or a Gaussian Naive Bayes ML model.

5. The system of claim 2, wherein a weight is assigned to each of the chargeback dispute variables for training the evidence recommendation ML model.

6. The system of claim 1, wherein the dispute evidence comprises a primary evidence type, a secondary evidence type, and a tertiary evidence type based on a probability of the merchant winning the resolution when submitting each of the primary evidence type, the secondary evidence type, and the tertiary evidence type, and wherein the requesting the dispute evidence comprises displaying the probability with the primary evidence type, the secondary evidence type, and the tertiary evidence type in a user interface for the dispute resolution request.

7. The system of claim 6, wherein the operations further comprise:
receiving merchant chargeback evidence for the chargeback from the merchant, wherein the merchant chargeback evidence is associated with at least one of the primary evidence type, the secondary evidence type, or the tertiary evidence type;
extracting text data from the merchant chargeback evidence; and
determining an updated probability of the merchant winning the resolution.

8. The system of claim 7, wherein the operations further comprise:
providing a recommendation for additional evidence for one of the primary evidence type, the secondary evidence type, or the tertiary evidence type based on the extracted text data or the updated probability.

9. The system of claim 7, wherein the operations further comprise:
submitting the merchant chargeback evidence for the dispute resolution request of the chargeback;
determining a dispute result of the dispute resolution request comprising whether the chargeback was resolved in favor of the customer or the merchant; and
retraining the ML engine based on the dispute result.

10. The system of claim 1, wherein prior to the requesting the dispute evidence, the operations further comprise:
accessing a digital evidence container associated with the merchant, wherein the digital evidence container comprises digital evidence associated with the chargeback; and
notifying the merchant of the digital evidence associated with the dispute evidence from the digital evidence container.

11. The system of claim 1, wherein the one or more data variables comprises at least one of a transaction category, a merchant category code, a currency, a chargeback reason, a chargeback reason code, or a payment processor type.

12. A method comprising:
receiving, via a dispute management interface from a merchant, a dispute of a transaction between a user and the merchant, wherein the dispute comprises a chargeback associated with the transaction;
determining a plurality of attributes associated with the dispute and the chargeback;
determining, using an evidence recommendation ML model based on the plurality of attributes, at least a primary evidence type and a secondary evidence type recommended for the merchant to provide in response to the dispute; and
providing, via the dispute management interface, a submission process for the primary evidence type and the secondary evidence type by the merchant for the dispute.

13. The method of claim 12, wherein the primary evidence type comprises a higher percentage of a successful resolution of the dispute for the merchant than the secondary evidence type, and wherein the method further comprises:
determining a plurality of tertiary evidence types recommended for the merchant to provide in response to the dispute, wherein two or more of the plurality of tertiary evidence types from the merchant improve chances for the successful resolution of the dispute for the merchant.

14. The method of claim 12, wherein the evidence recommendation ML model is trained using first training data associated with one of a first geolocation, a first region, or a first geodemographic segment, and wherein the first training data is based on first data compliance restrictions for the one of the first geographic location, the first region, or the first geodemographic segment.

15. The method of claim 12, further comprising:
determining, based on the first data compliance restrictions and a second data compliance restriction associated with one of a second geographic location, a first region, or a first geodemographic segment, whether deployment of the evidence recommendation ML model is available for the one of the second geographic location, the second region, or the second geodemographic segment.

16. The method of claim 15, further comprising:
in response to determining that the deployment of the evidence recommendation ML model is unavailable based on the first data compliance restriction and the second data compliance restriction, performing at least one of:
obfuscating at least a portion of the training data based on the second data compliance restriction, or
training an additional evidence recommendation ML model using one of the obfuscated training data or second training data in compliance with the second data compliance restriction.

17. The method of claim 15, wherein the first training data is associated with the merchant for the dispute, and wherein the method further comprises:
identifying the merchant as being located in both of the one of the first and second geographic locations, the first and second regions, or the first and second geodemographic segments; and
in response to determining that the deployment of the evidence recommendation ML model is available based on the identifying, deploying the evidence recommendation ML model in the one of the second geographic location, the second region, or the second geodemographic segment for the merchant.

18. The method of claim 12, further comprising:
determining a product lifecycle for a product associated with the dispute,
wherein the primary evidence type and the secondary evidence type are further determined by the evidence recommendation ML model based on the product lifecycle.

19. A non-transitory machine-readable medium having stored thereon machine-readable instructions executable to cause a machine to perform operations comprising:
accessing training data comprising a plurality of chargeback disputes, a result for each of plurality of chargeback disputes, and evidence submitted by a merchant for each of the plurality of chargeback disputes;
extracting, using at least one of text extraction or optical character recognition, text data from the evidence;
classifying, using an evidence classification machine learning (ML) model based on the text data, the evidence for each of the plurality of chargeback disputes as one or more of a plurality of evidence types provided during a dispute resolution process for the plurality of chargeback disputes; and
training a ML model for evidence recommendation during the dispute resolution process using the result for each of the plurality of chargeback disputes and the classified evidence.

20. The non-transitory machine-readable medium of claim 19, wherein the operations further comprise:
receiving an additional result of an additional chargeback dispute with additional evidence provided during the additional chargeback dispute; and
retraining the ML model based on the additional result and the additional evidence.
